(19) United States
(12) Patent Application Publication
(10) Pub. No.: US 2025/0024347 A1
(43) Pub. Date: Jan. 16, 2025

(54) A METHOD OF, A NODE DEVICE AND A SYSTEM FOR CONTROLLING A RELAY FEATURE OF A NODE DEVICE IN A MESH NETWORK

(71) Applicant: SIGNIFY HOLDING B.V., EINDHOVEN (NL)

(72) Inventor: MANGESH PANDURANG GADRE, PUNE (IN)

(21) Appl. No.: 18/709,870

(22) PCT Filed: Nov. 14, 2022
(86) PCT No.: PCT/EP2022/081723

§ 371 Date: May 14, 2024

(30) Foreign Application Priority Data
Nov. 24, 2021 (IN) 202141054196
Jan. 11, 2022 (EP) 22150972.2

(51) Int. Cl. H04W 40/22; H04W 40/24

(52) U.S. Cl. CPC H04W 40/22; H04W 40/246

(57) ABSTRACT

A method of controlling a relay feature of a first node device in a mesh network is disclosed. The network comprises a plurality of operatively interconnected node devices including the first node device and a number of furthe node devices, a relay feature of each node device having an initial status of being enabled. The method is performed by the first node device and comprises the steps of: receiving a relay optimization message; transmitting a neighbor relay discovery request to the number of further node devices, after a random waiting period; awaiting neighbor relay discovery responses from the number of further node devices until expiration of a response period started upon transmission of the neighbor relay discovery request, wherein a neighbor relay discovery response is received from a further node device when the further node device operates in a responding mode; disabling its relay feature if a number of the neighbor relay discovery responses is more than or equal to a threshold value.

### TECHNICAL FIELD

The present disclosure generally relates to the field of wireless communication network, more specifically, to a method of, a node device and a system for controlling a relay feature of a node device in a mesh network.

### BACKGROUND

A network topology connecting a plurality of node devices is referred to as mesh network, in which a node device may be connected directly, dynamically and non-hierarchically to many other node devices within its communication range, with the node devices cooperating with one another to efficiently route data between the node devices. This lack of dependency on one central node allows for every node to participate in the relay of information.

Mesh networks can relay messages using either a flooding technique or a routing technique. In a flood-based mesh network of large size, such as a Bluetooth mesh based network with for example more than 200 nodes, if the relay feature is kept ON for all node devices in the mesh network, it will lead to large network traffic, despite that retransmission of messages received is limited by a Time to live, TTL, value. In contrast, if the relay feature is turned off improperly for some node devices, it may result in a reduced range or distance that a message can travel.

US2017295455A1 relates to optimization of relay node in a mesh network disclosing that a first node will transmit a message to its neighboring nodes and enables its relay feature if at least one indication message from other nodes is received. It further discloses that a node device will transmit an indication message indicative of the enabling of a relay function to an neighboring node if a message having the same SRC address as the first message is not present.

US2020092792A1 discloses a method of deactivating a relay feature of a relay node in a mesh network based on connectivity among node devices.

Currently, there is no efficient method available, such as defined per Bluetooth mesh specification, for controlling the relay feature for the mesh network overall as a whole in an optimal way. Based on Bluetooth mesh specification, the relay feature of each node device is controlled manually by for example a mesh network provisioning person, which is inefficient both cost- and labor-wise.

Therefore, there is a genuine need for a method of optimizing control features of node devices in a mesh network such that it optimally contributes to message propagation and also helps reduce extra mesh traffic.

### SUMMARY

It is an object of the present disclosure to provide a method that allows each node in network to determine for itself whether its relay feature should be kept ON or turned off in such a way that message propagation and traffic in the network is optimized. Such a relay configuration is automatic and decided by mesh network nodes themselves without provisioner intervention.

In a first aspect of the present disclosure, there is presented a method of controlling a first node device in a mesh network comprising a plurality of operatively interconnected node devices including the first node device and a number of further node devices, a relay feature of each node device having an initial status of being enabled, the method performed by the first node device and comprising the steps of:
receiving a relay optimization message;
transmitting a neighbor relay discovery request to the number of further node devices after a random waiting period;
awaiting neighbor relay discovery responses from the number of further node devices until expiration of a response period started upon transmission of the neighbor relay discovery request, wherein a neighbor relay discovery response is received from a further node device when the further node device operates in a responding mode;
disabling its relay feature if a number of the neighbor relay discovery responses is more than or equal to a threshold value.

The present disclosure is based on the insight that by transmitting a neighbor relay discovery request to and receiving neighbor relay discovery responses that indicate relay status of a number of further node devices located in the neighborhood of a first node device from the further node devices, the first node device, which is connected to a mesh network, will be able to decide if its relay feature should be kept on or turned off.

To this end, the first node device is configured to operate under or initiate a state of discovering relay status of neighboring node devices, the state being triggered by a relay optimization message. The first node device, when operating in the discovery state, will start a relay feature optimization procedure by transmitting a neighbor relay discovery request, when a relay optimization message is received. The first node device then awaits neighbor relay discovery responses from the number of further node devices receiving the neighbor relay discovery request during a response period. By counting a number of responses that are transmitted by the further neighboring node devices in response to the neighbor relay discovery request that it transmits, the first node device will be able to tell if some node devices located in its neighborhood are currently having their relay feature enabled.

In the case that the number of response received is more than or equal to a threshold value, such as one, indicating that a further node devices in the neighborhood of the node device can currently relay messages, the node device will turn off its own relay feature.

This allows relay features of a number of node devices to be optimized in terms of their operating status of being turned on and off, such that network traffic is kept reasonably low while messages can still be relayed within an appropriate range in the mesh network.

Before initiating the relay optimization procedure by transmitting the neighbor relay discovery request, the first node device waits a random period, after receiving the relay optimization message.

This helps to prevent a scenario where all node devices will issue a neighbor relay discovery request at the same time. Having each node device optimizing its relay feature at differentiated time points allows the relay features of node devices in the network to be enabled or disabled in a more balanced way.

In an example of the present disclosure, the method further comprising the step of:
entering a responding mode if the number of the neighbor relay discovery responses is lower than the threshold value after expiration of the response period; and
sending a neighbor relay discovery response in response to a neighbor relay discovery request received in the responding mode.

If the number of neighbor relay discovery responses received by the first node device is below the threshold value, it shows that neighboring node devices around the first node devices have their relay feature turned off and will not relay messages that they receive. In this case, the first node device keeps its relay feature on and enters a responding mode. In this responding mode, the first node device will respond to neighbor relay discovery request(s) that other node devices in its neighborhood transmits, allowing other node devices to optimize their relay feature.

The relay optimization message is sent to a group of node devices to optimize their relay features. As described above, different node devices in the group take turns to optimize their relay features by sending the neighbor relay discovery request to other node devices.

In practice, a neighboring node device receiving the neighbor relay discovery request will only transmit a response to the node device sending the neighbor relay discovery request when its relay feature is on and itself is not in a procedure of optimizing its relay feature by transmitting a neighbor relay discovery request or awaiting responses from other node devices, nor when it is responding to a neighbor relay discovery request. This helps to ensure more reliable determination of a status of relay features of neighboring node devices.

In an example of the present disclosure, the relay optimization message is received from a control device external to the network or from a firmware internal to the first node device.

The relay optimization message functions as a trigger message for triggering a relay optimization procedure. It allows the optimization of the relay features of node devices in the network to be performed in a controlled way.

As an example, the control device external to the network may be a provisioner device or a backend server.

Depending on whether the node device is enabled with short or long range communication capabilities, the relay optimization message may be transmitted from a mobile device such as a portable provisioning device via short range communication or from a backend server via long range communication.

Receiving the relay optimization message from the backend server via long range communication comprises receiving the relay optimization message directly from the backend server, when the node device support a long range communication interface. Alternatively, if the node device does not support a long range communication interface, it may receive the relay optimization message from the backend server by way of delegation via a further node device supporting a long range communication interface and therefore can communicate with the backend server directly.

Alternatively, firmware can run discovery on its own on the node device at a predetermined time, such as once in a week.

In an example of the present disclosure, the response period is a random time period or a fixed time period.

It can be contemplated by those skilled in the art the response period may be set, to a fixed value or by conveniently keeping it random, based on various factors such as a size of the network, the number of node devices being optimized and so on.

In an example of the present disclosure, transmitting a neighbor relay discovery request to a number of further node devices comprises setting a time to live, TTL, value for the neighbor relay discovery request.

Setting a TTL value for the neighbor relay discovery request transmitted by the node device allows the message to be transmitted only a limited number of hops, thereby realizing the purpose of having it transmitted to the number of further node device. This is also readily available setting which can be easily used.

The transmitting may be performed using for example flooding. This is standard message transmission technique used in mesh networks. It can be used conveniently to transmit the neighbor relay discovery request.

As an example, the TTL may be set to two. This TTL value, in combination with the threshold value of received responses that is used to determine whether the relay feature of the node device should be disable, may be used to adjust a number of node devices needing to have their relay feature disabled.

It can be contemplated by those skilled in the art fewer node devices will have an enabled relay feature if the TTL is set to a higher value while the threshold value of received responses is set to a lower value. On the other hand, if one expects more node devices to have their relay feature enabled, the TTL may be set to a lower value while the threshold value of received responses is set to a higher value.

When the TTL is set to two, the neighbor relay discovery request travels only up to one hop. This setting provides relatively low traffic in the network while still maintaining reliable relay of messages across the network.

In one example, the threshold value may be set to one. This means that if the node device notice that one other node device in its neighborhood has its relay feature enabled, it will switch off its own relay feature.

In an example of the present disclosure, the method further comprises a step of transmitting a status update notification to a control device for recording.

The control device may maintain a relay status for each node device in the network, As the node device has its relay feature disabled now, it transmits a status update message to the control device, such that its relay status as maintained by the control device may be updated. It allows the control device to have up-to-date knowledge about node devices in the network, and thereby more appropriate timing to send the relay optimization message to necessary node devices.

In practice, the relay optimization message may comprise a discovery period, which when being received by the node device, will trigger the start a relay discovery timer for a discovery period. When the timer runs out, the discovery or optimization will not be running anymore. This ensures that the relay optimization procedure as triggered by the relay optimization message does not keeping running for a long time.

The discovery period may be decided by an application running on the control device transmitting relay optimization message or as programmed in the firmware within the node device, on the basis of a total number of nodes in the group being optimized for their relay features. For example, for a group comprising 20 nodes, the discovery period may be set to 5 minutes.

A second aspect of the present disclosure provides a node device arranged for controlling its relay feature according to the method according to the first aspect of the present disclosure. The node device is connected in a mesh network comprising plurality of operatively interconnected node devices, a relay feature of each node device has an initial status of being enabled.

A third aspect of the present disclosure provides a system for controlling a relay feature of a first node device in a mesh network, the mesh network comprising a plurality of operatively interconnected node devices including the first node device and a number of further node devices, a relay feature of each node device having an initial status of being enabled, wherein:
each of the node devices is configured to receive a relay optimization message;
a first node device is configured to transmit a neighbor relay discovery request to the number of further node devices, after a random waiting period after receiving the relay optimization message;
the number of further node devices are configured to receive the neighbor relay discovery request;
a further node device is configured to transmit a neighbor relay discovery response to the first node device in response to receiving the neighbor relay discovery request, when the further node device operates in a responding mode;
the first node device is further configured to:
   await neighbor relay discovery responses from the number of further node devices until expiration of a response period started upon transmission of the neighbor relay discovery request; and
   disable its relay feature if a number of the neighbor relay discovery responses is more than or equal to a threshold value.

From a system perspective of view, interactions between a first node device optimizing its relay feature and a number of further node devices in the neighborhood are generally as described in the above system.

It is noted that a node device in the network may function both as a first node device optimizing its relay feature by transmitting a neighbor relay discovery request and as a further node device responding to a neighbor relay discovery request when operating in the responding mode. In this sense a first node device and a further node device may not necessarily refer to separate node devices. Instead, a same node device may assume the role of either first node device or a further node device at different points of time.

In an example of the present disclosure, the relay optimization message further comprises a discovery period, each of the number of further node devices is configured to respond to a neighbor relay discovery request only before expiration of the discovery period.

This discovery period is set to terminate the optimization, which expires when the node devices have successfully optimized their relay features.

In a further example, the first node device is further configured to:
enter a responding mode if the number of the neighbor relay discovery responses is lower than the threshold value after expiration of the response period; and
send a neighbor relay discovery response in response to a neighbor relay discovery request received in the responding mode.

When the first node device keeps its relay feature on, it can respond to neighbor relay discovery request(s) from other node devices, facilitating those node devices to optimize their relay features.

When the first node device, as a result of optimizing its relay feature, turns off the relay function, it will not respond to neighbor relay discovery request from another node device anymore.

A fourth aspect of the present disclosure provides a method for controlling a relay feature of a first node device in a mesh network comprising a plurality of operatively interconnected node devices including the first device and a number of further node devices, a relay feature of each node device having an initial status of being enabled, the method comprising the steps of:
receiving, by each of the node devices, a relay optimization message;
transmitting, by a first node device, a neighbor relay discovery request to the number of further node devices, after a random waiting period;
receiving, by the number of further node devices, the neighbor relay discovery request;
transmitting, by a further node device, a neighbor relay discovery response to the first node device, when the further node device operates in a responding mode;
awaiting, by the first node device, neighbor relay discovery responses from the number of further node devices until expiry of a response started upon transmission of the neighbor relay discovery request;
disabling, by the first node device, its relay feature if a number of the neighbor relay discovery responses is more than or equal to a threshold value.

Operations by node devices in the system for optimizing relay features of the node devices are generally as described in the above method.

In an example of the present disclosure, further comprising the step of:
entering, by the first node device, a responding mode if the number of the neighbor relay discovery responses is lower than the threshold value after expiration of the response period; and
sending, by the first node device, a neighbor relay discovery response in response to a neighbor relay discovery request received in the responding mode.

As discussed above, the first node device can operate to optimize its relay function or to respond to neighbor relay discovery request, facilitating other node devices to optimize their relay features. The operations of the node devices may be implemented by configuring the node devices to operate under different modes when satisfying conditions for performing the operation.

As an example, the relay optimization message further comprises a discovery period, the method further comprising: responding, by each node device, to a neighbor relay discovery request in responding mode only before expiration of the discovery period.

When the discovery period expires, the optimization procedure is not running anymore, so the node devices does not respond to any neighbor relay discovery request, it also helps to reduce traffic in the network.

A fifth aspect of the present disclosure provides a computer program product, comprising a computer readable storage medium storing instructions which, when executed on at least one processor, cause said at least one processor to carry out the method according to the first aspect of the present disclosure.

The above mentioned and other features and advantages of the disclosure will be best understood from the following description referring to the attached drawings. In the drawings, like reference numerals denote identical parts or parts performing an identical or comparable function or operation.

### BRIEF DESCRIPTION OF THE DRAWINGS

FIG. 1 schematically illustrates a mesh network comprising a plurality of node devices;

FIG. 2 schematically illustrates a neighbor client model and a neighbor server model running on a node device and cycling between different states;

FIG. 3 is a sequence diagram schematically illustrating a method of controlling a relay feature of a node device;

FIG. 4 schematically illustrates method of controlling a relay feature of node devices in a mesh network, from the perspective of a node device optimizing its relay function.

### DETAILED DESCRIPTION

Embodiments contemplated by the present disclosure will now be described in more detail with reference to the accompanying drawings. The disclosed subject matter should not be construed as limited to only the embodiments set forth herein. Rather, the illustrated embodiments are provided by way of example to convey the scope of the subject matter to those skilled in the art.

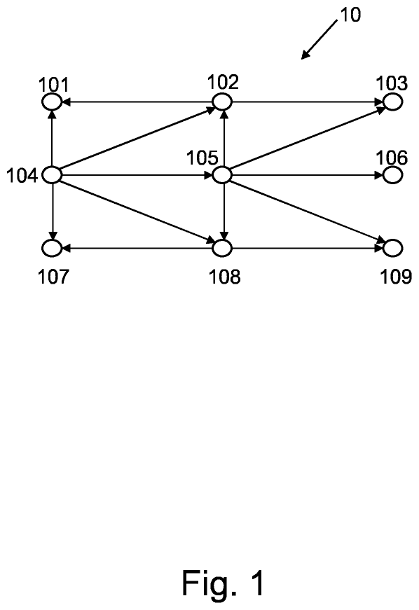

FIG. 1 schematically illustrates a mesh network 10 comprising a plurality of node devices 101-109. Each node device can communication with a further node device in the network 10 via direct communication or by way of relay via another node device.

Node devices forming a network as contemplated by the present disclosure all support a relay feature. It is assumed that each node device has an initial status of having its relay feature enabled, after installation and provisioning of the network.

The present disclosure proposes a method which allows each node device in the network to determine automatically whether its relay feature should be kept enabled or disabled.

A node device in a mesh network such as a Bluetooth network may operate a plurality of models such as a server model, a client model and a control model. Each model defines a plurality of operation states, messages that act upon those states, and any associated behavior.

In accordance with the inventive idea of the present disclosure, a method of controlling a relay feature of a node device in a mesh network is implemented by alternately operating each node device in a neighbor server mode and a neighbor client mode.

The neighbor server mode and neighbor client mode are configured for each node device, which may be realized for example using the above models of Bluetooth nodes. Specifically, two new models respectively referred to as a neighbor server model and a neighbor client model are added for all mesh nodes in a mesh network.

When provisioning the network comprising a plurality of node devices, relay features of all mesh nodes in the network are turned on. For convenience purposes, relay features of mesh node devices may be optimized group by group. That is, node devices of a same group will be considered for relay optimization, which will be elaborated in more detail below.

In a Bluetooth mesh network, a neighbor server has a same subscription address as a neighbor client Publication address.

For the purpose of controlling a number of hops each message is relayed in the mesh network, a control parameter such as a Time To Live, TTL, may be used. As an example, setting TTL of a node device operating in the client mode, that is, running neighbor client model, to 2 allows messages from the node device operating to travel up to 1 hop.

At the client mode, a node device determines a number of neighboring node devices having its relay feature enabled by transmitting a neighbor relay discovery request. When the node device finds that node device having their relay feature enabled is above or equal to a threshold value, it will disable its own relay feature. The threshold maybe set to for example 1, which means the node device will turn off its relay feature if there is another node device in its neighborhood has its relay feature enabled.

When operating under the neighbor server mode, the node device listens to relay discovery requests from node devices operating in the neighbor client mode and transmits a response message but does not publish responses.

A node operating the neighbor server model, or simply referred to as a neighbor server, maintains a relay state value and cycles through three states Discovery Off, ServerBusy and ServerRunning.

On the other hand, a node device operating the neighbor client model, or simply referred to as a neighbor client, cycles through four states, that is, Discovery Off, Client Not Active, Discovery request Sent and Response Pending. The neighbor client node maintains a counter for neighbors relay count and a client response timeout in seconds. The neighbor relay count is used to count a number of neighboring node devices having their relay features turned on.

It can be contemplated by those skilled in the art both neighbor server and neighbor client models are present on each node device. Only one of the neighbor server and neighbor client models will be active at a time. Client and Server state machines are triggered with events, while states of the client server and the neighbor server are affected by each other.

Specifically, when the neighbor client model is not active, the neighbor server model will be in Running State, and vice versa. The purpose of not keeping the neighbor client and neighbor server models active at the same time is to avoid contention of Relay state reported between neighboring nodes.

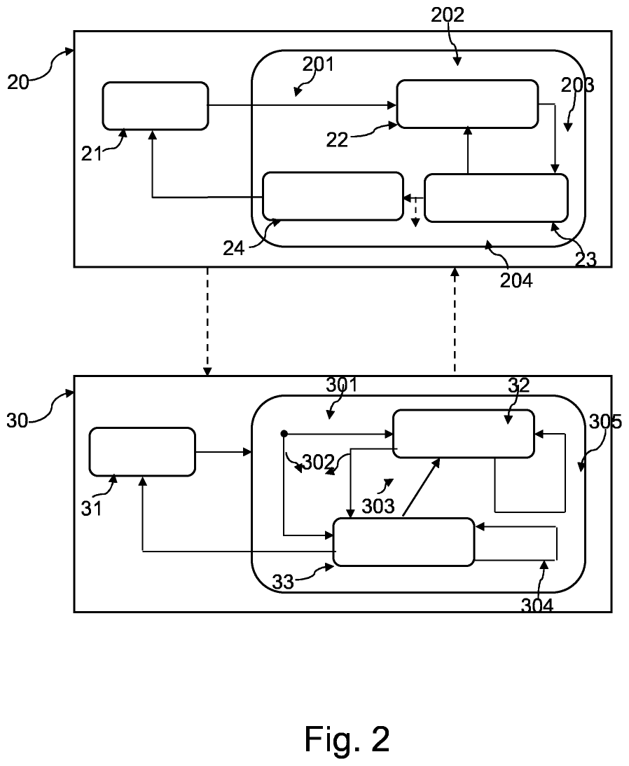

FIG. 2 schematically illustrates a neighbor client model 20 and a neighbor server model 30 running on a node device and cycling between different states.

In a normal operation status of the node device, the node device is in a discovery off mode for both the neighbor client 21 and the neighbor server 31.

Upon starting relay discovery 201, which may be initiated by the node device receiving a discovery start command or instruction from an external device, such as a mobile device operating as a provisioner or a backend server, or an instruction generated by a firmware of the node device, the node device will initially start working like a neighbor server 30.

The neighbor client 20 at this time, may start a timer for the discovery timeout period, which is indicated as 202. At the same time, the neighbor client 20 of the node device enters a Client Request Pending mode 22.

After a random waiting period 203, in other words, at a random time instance during the discovery timeout period, the node device will start to operate the neighbor client model 20 and send a neighbor relay discovery command to its immediate neighboring node devices. The neighbor client 20 thereby enters a Client Response Pending state 23.

The Client Response Pending state 23 last a period determined by a client wait timeout counter 204. During this period 204, neighboring node devices running neighbor server and having their relay feature turned ON will respond to the client request, that is, the neighbor relay discovery command.

When the client wait time out 204, the node device ends its neighbor client, therefore, the client not active state 24 will be running.

When the neighbor client 20 is running 301 on the node device, the neighbor server 30 on the same node device is in a Serve Busy 32 state. Otherwise, when the neighbor client 20 is not active 302, the neighbor server 30 will be in the Server running 33 state.

As described above, when in the Server running 33 state, once receiving a client request 303, the neighbor server 30 will switch to the Server Busy 32.

When in the Server running 33 state, the neighbor server 30 will respond to the client request received from a node device running neighbor client, with its relay status 304, if its relay feature is ON.

If a client request is received when Server is busy 32, server busy response 305 will be returned to the neighbor client. In this case, the node device running neighbor client will re-attempt transmission of same request after some time within relay discovery timeout.

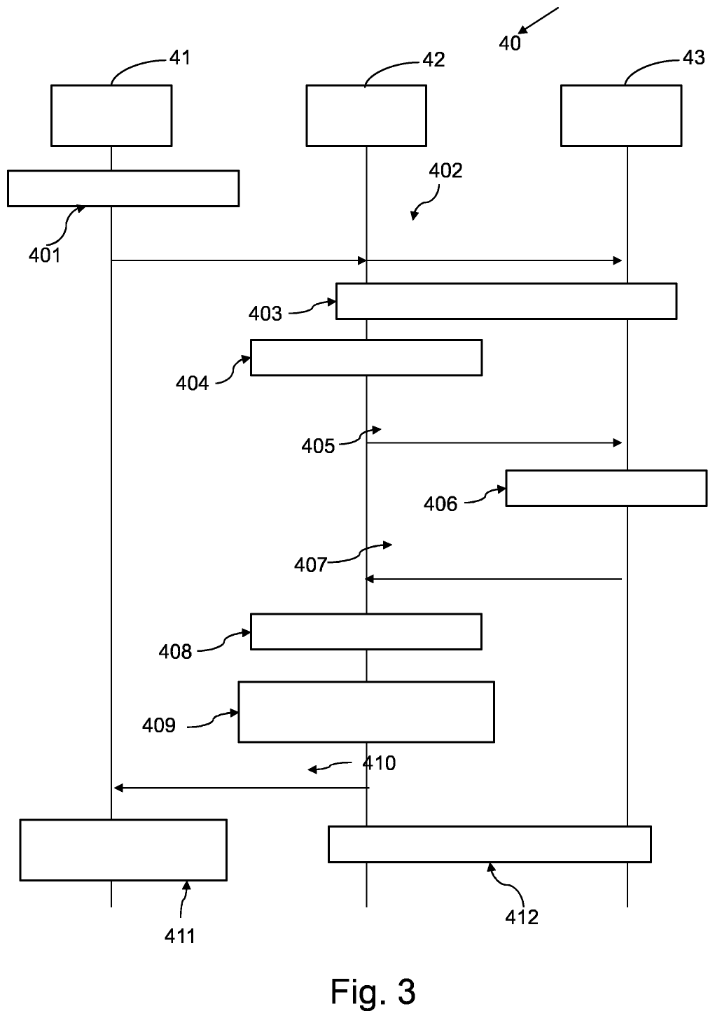

Operations by different entities in a system implementing a method of controlling a relay feature of a node device in a mesh network will be described in the following with reference to FIG. 3, which is a sequence diagram schematically illustrating a method 40 of controlling a relay feature of a node device.

The system may comprise a control device 41, which may be for example a provisioner device or a backend management server, and a plurality of node devices. Relay features of the node devices may be updated group by group, with each group comprising a number of node devices, such as five to ten node devices physically located close to each other.

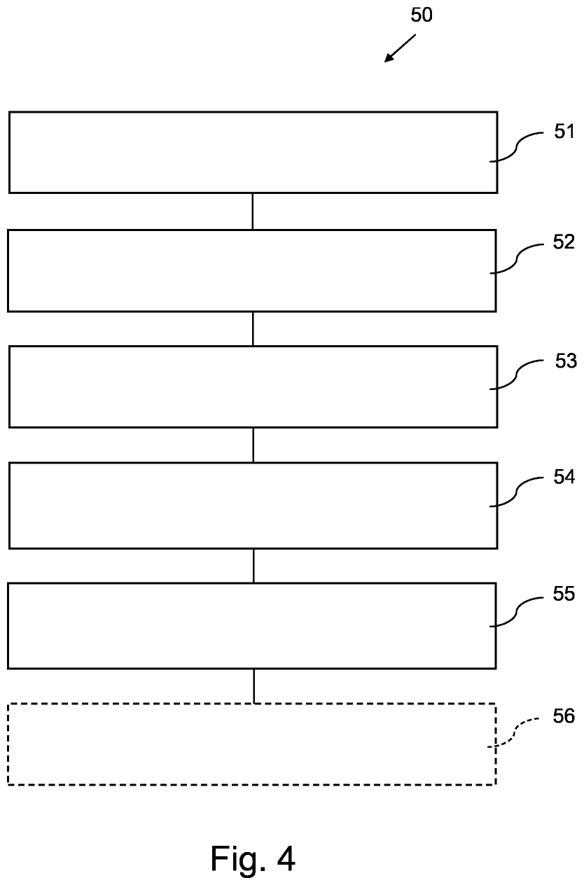

As described above, each node device may operate a neighbor client model and a neighbor server model. In the method to be described below, the procedure of relay optimization is described to a scenario of one node device operating as a neighbor client 42 and a plurality of neighboring node devices operating as neighbor servers 43, though only one neighbor server 43 is illustrated in FIG. 4.

At step 401, the control device 41 decides to start relay optimization. The control device therefore transmits 402 a relay optimization command to a group of node devices, which up till now operate in discovery off mode.

Upon receiving the relay optimization command, each of the group of node devices start a timer for discovery 403, which set a certain period for the discovery procedure.

During this discovery period, a node device first wait for a random period 404, before initiating operation of the neighbor client 42 and sending a relay discovery request 405 to other node devices. The transmission of the relay discovery request also triggers a response period for collecting responses from other node devices.

A node device operating neighbor server 43 receiving the relay discovery request message, when in a servery busy state, will reply a server busy message to the neighbor client 42. The node device running neighbor client 42 will re-attempt transmission of same request after some time within relay discovery period.

If the node device operating neighbor server 43 receiving the relay discovery request message is not in servery busy state, it will check its relay status 406. When its relay status is on, which means the relay feature of this node device is enabled, the node device operating neighbor server 43 will send a relay discovery response 407 message to the neighbor client 42.

Responses from neighbor server 43 are collected 408 during the response period, with each received relay discovery response, the neighbor client may increase the neighbor relay counter by one. At the end of the response period, if the neighbor relay count is higher than or equal to a threshold value, such as 1, the node device operating the neighbor client 42 will switch off its relay feature 409.

The node device operating the neighbor client 42 will then send a relay update message 410 to the control device 41, which will update a relay status on the node devices 411 that it maintains locally or remotely.

After the timer for discovery runs out 412, all node devices in the group being optimized for their relay features enter into discovery off state.

A method 50 of controlling a relay feature of a node device in a mesh network will be described in the following with reference to FIG. 4, from the perspective of a node device operating the neighbor client model, according to an embodiment of the present disclosure.

At step 51, the node device receives a relay optimization message. The relay optimization message may be sent from a network managing device, such as a mobile device via short range communication or a backend server via long range communications. As an example, a Mobile App running on a mobile device by a field engineer may send a Relay Optimization message to group address.

Discovery process may also be started when neighbor discovery command is received from the node device itself. As an example, a firmware can run discovery on its own on all nodes at predetermined time example once in a week. This allows removed node devices to be taken care of.

The relay optimization message may be transmitted to a group of node devices. It can be contemplated that a group address as defined by the Bluetooth specification may be used to transmit such a message to a group of node devices in a Bluetooth network. The grouping of node devices may be determined based on geographic locations of network address of the node devices.

The relay optimization message may also comprise a discovery period. Upon receiving the relay optimization message, the node device will start a discovery timer, which defines a period of time for the discovery procedure to run.

At step 52, the node device waits for a random time.

For the purpose of avoiding that all node devices receiving the relay optimization message from issuing a neighbor relay discovery request at a same time, the neighbor relay discovery request is not transmitted by the node device right away after entering the discovery procedure. Instead, the message is transmitted after a random delay. This enables that different node devices running the client mode and in the same group will not transmit the relay discovery request simultaneously.

An example is that on random discovery time instance in given discovery timeout period, a node device in client mode publishes Neighbour Relay Discovery request.

At step 53, the node device transmits a neighbor relay discovery request.

The node device at this moment starts to operate its neighbor client model. The relay discovery request is transmitted for example by flooding. Moreover, to limit the number of node devices that may receive the relay discovery request, a time to live, TTL, maybe set for the message. The TTL is used to control an optimization range in the network. A bigger TTL allows more mode devices to receive the relay discovery request, thereby optimizing the relay feature of a bigger group of node devices, while a smaller TTL allows fewer node devices to optimize their relay features.

The TTL may be set to two, which allows the message to be transmitted for only one hop.

At step 54, the node device awaits responses from neighboring node devices until a defined response period is time out.

The response period starts to run when the neighbor relay discovery request is sent, which is used to control a period within which the node device awaits response from neighboring node device. The response period may be a fixed period or a period with random length. The node device in client mode waits till the response period runs out.

It is noted that only node devices operating the neighbor server model and with Relay Feature turned ON will respond to client request. When the node device is operating the neighbor server model but is responding to a neighbor relay discovery request from a different node device, it will not transmit the response. Instead, it will transmit a server busy message to the node device. The node device may try to re-transmit the neighbor relay discovery request again within the discovery period.

The node device may also keep a counter for the number of received responses. On each received response it increments the counter by one.

At step 55, after the response period runs out, if a total number of relay responses received by the node device in the client mode is more than or equal to a threshold value, such as 1 or 2, it will turn off its own relay.

A received response means that the relay feature of the node device sending the response is currently enabled. As the node device sending the response is located relatively close (this is controlled by setting the TTL for the relay discovery request), the node device can therefore switch off its own relay feature, which will not significantly deteriorate transmission range of message relayed in the network, while helping to reduce the network traffic.

At step 56, the node device sends an updated notification to the control device such that the control device may update the status of the node device in terms of its relay feature accordingly.

This is because after the above described relay optimization operation is complete, some node devices will turn off their relay features while others will not. Therefore updated relay status notification from nodes shall be sent to the control device.

The node device may also keep its relay feature on when the number of response received from other node devices is below the threshold value. In this case, the node device will enter the so called server mode and will be able to response to neighbor relay discovery requests from other node devices, allow other node devices to optimize their relay features.

In implementing the above method, the following has to be noted:

When the client mode on a node device is not active, the server mode runs on the node device and it will respond to client requests from neighboring node devices operating in the client mode. Besides, a node device running the server mode will respond to relay discovery request from a node device running the client mode it is not publishing responses.

The discovery procedure lasts a defined period, which may be adjusted based on a size of the mesh network. After the discovery period is timeout, server and client enter a Discovery Off state.

The present disclosure is not limited to the examples as disclosed above, and can be modified and enhanced by those skilled in the art beyond the scope of the present disclosure as disclosed in the appended claims without having to apply inventive skills and for use in any data communication, data exchange and data processing environment, system or network.

1. A method of controlling a relay feature of a first node device in a mesh network comprising a plurality of operatively interconnected node devices including the first node device and a number of further node devices, a relay feature of each node device having an initial status of being enabled, the method performed by the first node device and comprising:
receiving a relay optimization message;
transmitting a neighbor relay discovery request to the number of further node devices after a random waiting period;
awaiting neighbor relay discovery responses from the number of further node devices until expiration of a response period started upon transmission of the neighbor relay discovery request, wherein a neighbor relay discovery response is received from a further node device when the further node device operates in a responding mode;
disabling its relay feature if a number of the neighbor relay discovery responses is more than or equal to a threshold value; and
entering a responding mode, performed by the first node device, if the number of the neighbor relay discovery responses is lower than the threshold value after expiration of the response period; and
sending a neighbor relay discovery response in response to a neighbor relay discovery request received in the responding mode.

2. The method according to claim 1, wherein the relay optimization message further comprises a discovery period and said random waiting period occurs during the discovery period, the method further comprises:
responding, by the first node device, to a neighbor relay discovery request only before expiration of the discovery period.

3. The method according to claim 1, wherein the relay optimization message is received from a control device external to the mesh network or from a firmware internal to the first node device.

4. The method according to claim 1, wherein the response period is a random time period or a fixed time period.

5. The method according to claim 1, wherein transmitting a neighbor relay discovery request to a number of further node devices comprises setting a time to live, TTL, value for the neighbor relay discovery request.

6. The method according to claim 1, wherein the threshold value is one.

7. The method according to claim 1, further comprising a step of transmitting a relay status update notification to a control device for recording.

8. A node device configured to control its relay feature according to the method according to claim 1, the node device being connected in a mesh network comprising plurality of operatively interconnected node devices, a relay feature of each node device having an initial status of being enabled.

9. A mesh network, comprising a plurality of node devices as claimed in claim 8.

10. A non-transitory computer readable storage medium storing instructions which, when executed on at least one processor, cause said at least one processor to carry out the method according to claim 1.
